(19) United States
(12) Patent Application Publication
(10) Pub. No.: US 2010/0240500 A1
(43) Pub. Date: Sep. 23, 2010

(54) Handle for skipping rope and method for making the same

(76) Inventor: Su Youl KIM, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/509,181

(22) Filed: Jul. 24, 2009

(30) Foreign Application Priority Data
Mar. 23, 2009 (KR) 2009-24279

(51) Int. Cl. A63B 5/20; B29C 41/22

(52) U.S. Cl. 482/82; 264/74

(57) ABSTRACT

A method for forming recess patterns in a handle of a skipping rope includes the steps of preparing materials for forming the handle and a filler made of rubber materials having a certain color, forming the recess patterns in the surface of the handle while making the handle with synthetic resins, and filling the recess patterns with the filler and solidifying the filler to form in a body with the handle.

The filler is made of rubber materials and thereby it can be prevent the handle slipping from a user's hand. Further, the recess patterns can have various shapes and the filler can has various colors and thereby the appearance of the handle is beauty.

### BACKGROUND OF THE INVENTION

(1) Field of the Invention

The present invention relates to a skipping rope, more particularly to an improved handle for a skipping rope and a method for making the handle to prevent it slipping from a user's hands.

(2) Description of the Related Arts

Skipping rope is primary tool used in the game of skipping by children and many young adults. Exercises using the skipping rope are widely welcomed by people because of its simple action. In addition, the exercises using the skipping rope are good for health and fitness. In order to use more conveniently and easily, the skipping rope has been developed to improve its function.

The skipping rope comprises two handles and a rope between the handles. The length of the rope is adjusted according to a user's height. The rope is coupled with the handles by various means.

Conventional handle for a skipping rope made of plastic materials and has not other functions besides holding. Accordingly, the handle can be slipped from a user's hands so that it is difficult to exercise effectively.

Further, the conventional skipping rope is of poor quality because the color and appearance of the handle are simple.

### SUMMARY OF THE INVENTION

The present invention has been developed to solve the problems with above-described skipping rope.

It is an object of the present invention to provide an improved handle for a skipping rope and a method for making the handle capable of preventing it slipping from a user's hands.

It is another object of the present invention to provide an improved handle for a skipping rope having beautiful appearance.

Further objects will become apparent from the drawings and from the following detailed description.

In accomplishing the above and other objectives, a method for forming recess patterns in a handle of a skipping rope according to the present invention includes the steps of preparing materials for forming the handle and a filler made of rubber materials having a certain color, forming the recess patterns in the surface of the handle while making the handle with synthetic resins, and filling the recess patterns with the filler and solidifying the filler to form in a body with the handle.

A skipping rope according to the present invention includes a pair of handles and a rope connected between each end of each handle, wherein the handle has recess patterns arranged on the surface thereof, the recess patterns are filled with a filler made of rubber materials to prevent slipping, and the filler has a certain color.

The skipping rope according to the present invention has the effects as follows.

The filler formed on the surface of the handle is made of rubber materials and thereby it can be prevent the handle slipping from a user's hand. Therefore, the user can exercise more effectively with the skipping rope according to the present invention.

Further, the recess patterns can have various shapes and the filler can has various colors and thereby the appearance of the handle is beauty. Therefore, a high quality skipping rope can be provided.

### BRIEF DESCRIPTION OF THE DRAWINGS

FIG. 1 is a perspective view showing the handle for the skipping rope according to the present invention.

FIG. 2 is a front view showing the handle for the skipping rope according to the present invention.

FIG. 3 is a perspective view showing the handle for the skipping rope according to the present invention, where recess patterns of the handle for skipping rope are not filled with a filler.

FIG. 4 is a front cross-sectional view showing the handle for the skipping rope according to the present invention.

### DETAILED DESCRIPTION OF THE EMBODIMENTS

Referring now to attaching the drawings, a handle for a skipping rope according to an embodiment of the present invention will be described in detail. It is noted that like parts are designated by like reference numerals throughout the accompanying drawings.

(A Step for Preparing Materials)

Materials such as synthetic resins are prepared for forming the handle 10 for the skipping rope, and rubber materials are prepared for a filler 200. The rubber materials have a certain color.

(A Step for Forming Recess Patterns)

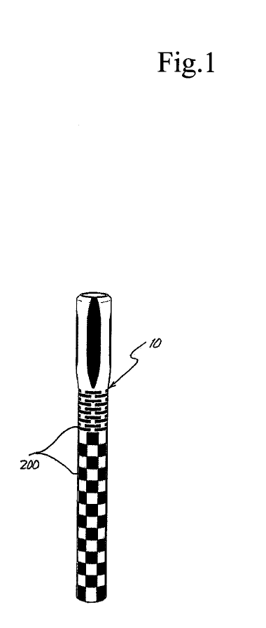

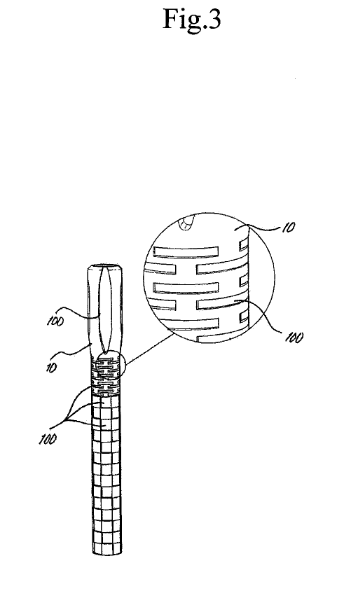

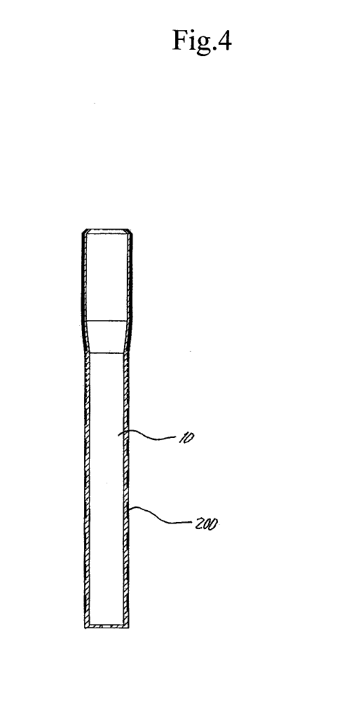

First, the handle 10 is formed with the synthetic resins. The recess patterns 100 are formed on the surface of the handle 10 while forming the handle 10. The shape of the recess patterns 100 is various, not limited to the shapes shown FIG. 1 to FIG. 4. For example, the shape of the recess patterns 100 may be a geometrical figure or characters.

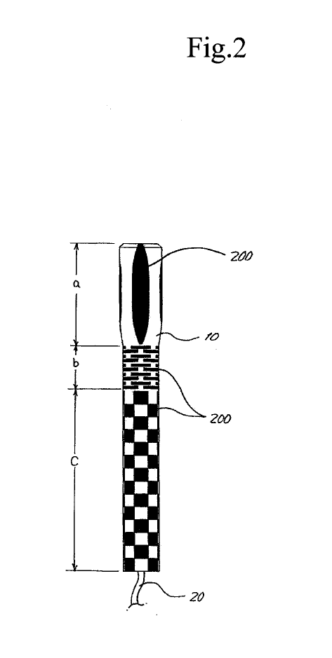

In FIG. 2, the surface of the handle 10 is divided into three sections a, b and c, and three different recess patterns 100 are formed on each section. Alternatively, only one recess pattern 100 may be formed on the surface of the handle 10.

(A Step for Filling with a Filler)

The recess patterns 100 of the handle 10 are filled with the filler 200 made of rubber materials. The filler 200 is filled in the melted state into the recess patterns 100, and after a predetermined time, the filler 200 is solidified to form in a body with the handle 10.

The shape of the filler 200 is set according to that of the recess patterns 100, and has a certain color. Further, different color may be applied to the body and the recess patterns 100 of the handle 10.

The filler 200 formed in the recess patterns 100 prevents the handle 10 slipping from a user's hand. For providing a high slip prevention effect, the filler 200 may be formed to protrude from the outer surface of the recess patterns 100.

After making a pair of handles for the skipping rope, a rope 20 is connected between each end of each handle 10, so that the skipping rope is completed.

What is claimed is:

1. A method for forming recess patterns in a handle of a skipping rope comprising the steps of:
preparing materials for forming the handle and a filler made of rubber materials having a certain color;
forming the recess patterns in the surface of the handle while making the handle with synthetic resins; and
filling the recess patterns with the filler and solidifying the filler to form in a body with the handle.

2. A skipping rope comprising:
a pair of handles; and
a rope connected between each end of each handle,
wherein the handle has recess patterns arranged on the surface thereof, the recess patterns are filled with a filler made of rubber materials to prevent slipping, and the filler has a certain color.
